(19) United States
(12) Patent Application Publication
(10) Pub. No.: US 2003/0074151 A1
(43) Pub. Date: Apr. 17, 2003

(54) Method and apparatus for balancing an article for rotation

(76) Inventor: Jeremy A. Rapp, Toledo, OH (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/270,089

(22) Filed: Oct. 14, 2002

Related U.S. Application Data
(60) Provisional application No. 60/328,746, filed on Oct. 12, 2001.

(51) Int. Cl. G06F 19/00; G01L 25/00

(52) U.S. Cl. 702/105

(57) ABSTRACT

A method and apparatus of balancing an article provides a visual indication that precisely defines the location of a balance weight that can be secured thereto. A balancing machine rotates the article and is responsive to vibrations for determining the size and location of one or more balance weights that, if secured to the article, will minimize or eliminate these imbalances. The balancing machine then ceases further rotation of the article and generates a first indication of the size of the balance weight that is necessary to counterbalance the sensed imbalance in the article and a second indication when the location on the article at which the balance weight is to be secured is oriented at the top dead center position of the article. At the same time, a light emitter emits a beam of light that causes a narrow line to be illuminated along the top dead center position of the article. As a result, a clear visual indication is provided to the operator of the proper location to secure the balance weight to the article. Lastly, the balance weight is secured to the article.

### CROSS REFERENCE TO RELATED APPLICATION

This application claims the benefit of U.S. Provisional Application No. 60/328,746, filed Oct. 12, 2001, the disclosure of which is incorporated herein by reference.

### BACKGROUND OF THE INVENTION

This invention relates in general to the balancing of an article for rotation about an axis. More specifically, this invention relates an improved method and apparatus for balancing an article for such rotation by providing a visual indication on the outer surface thereof that precisely identifies the location at which a balance weight can be secured to the article to balance it for rotation.

Drive train systems are widely used for generating power from a source and for transferring such power from the source to a driven mechanism. Frequently, the source generates rotational power, and such rotational power is transferred from the source to a rotatably driven mechanism. For example, in most land vehicles in use today, an engine/transmission assembly generates rotational power, and such rotational power is transferred from an output shaft of the engine/transmission assembly through a driveshaft assembly to an input shaft of an axle assembly so as to rotatably drive the wheels of the vehicle. To accomplish this, a typical driveshaft assembly includes a hollow cylindrical driveshaft tube having a pair of end fittings, such as a pair of tube yokes, secured to the front and rear ends thereof. The front end fitting forms a portion of a front universal joint that connects the output shaft of the engine/transmission assembly to the front end of the driveshaft tube. Similarly, the rear end fitting forms a portion of a rear universal joint that connects the rear end of the driveshaft tube to the input shaft of the axle assembly. The front and rear universal joints provide a rotational driving connection from the output shaft of the engine/transmission assembly through the driveshaft tube to the input shaft of the axle assembly, while accommodating a limited amount of angular misalignment between the rotational axes of these three shafts.

Ideally, the driveshaft tube would be formed in the shape of a cylinder that is absolutely round, absolutely straight, and has an absolutely uniform wall thickness. Such a perfectly shaped driveshaft tube would be precisely balanced for rotation and, therefore, would not generate any undesirable noise or vibration during use. In actual practice, however, the driveshaft tube and other components of the driveshaft assembly usually contain variations in roundness, straightness, and wall thickness that result in minor imbalances when rotated at high speeds. To prevent such imbalances from generating undesirable noise or vibration when rotated during use, therefore, it is commonplace to counteract such imbalances by securing balance weights to selected portions of the driveshaft tube or other components of the driveshaft assembly. The balance weights are sized and positioned to counterbalance the imbalances of the driveshaft assembly such that it is balanced for rotation during use.

Traditionally, the balancing process has been performed with the use of a conventional balancing machine. A typical balancing machine includes a pair of fittings that are adapted to support the ends of the driveshaft assembly thereon. The balancing machine further includes a motor for rotating the driveshaft assembly at a predetermined speed. As the driveshaft assembly is rotated, the balancing machine senses vibrations that are caused by imbalances in the structure of the driveshaft assembly. The balancing machine is responsive to such vibrations for determining the size and location of one or more balance weights that, if secured to the driveshaft assembly, will minimize these imbalances. The rotation of the driveshaft assembly is then stopped to allow such balance weights to be secured to the outer surface of the driveshaft tube or other components of the driveshaft assembly in a conventional manner, such as by welding, adhesives, and the like. The driveshaft assembly is again rotated to confirm whether proper balance has been achieved or to determine if additional balance weights are required. A number of such balancing machines of this general structure and method of operation are known in the art.

As mentioned above, the balancing machine ceases to rotate the driveshaft assembly to allow the balance weight to be secured to the outer surface thereof. To accomplish this, the balancing machine typically allows an operator to manually rotate the driveshaft assembly until the location at which a balance weight is to be secured to the driveshaft assembly is positioned facing directly upwardly (i.e., a top dead center position). The balancing machine typically provides a visual or audible indication to the operator when this top dead center orientation of the driveshaft assembly has been achieved. However, the operator of the balancing machine must visually determine the location of this top dead center orientation and manually position the balance weight at that location. Although this process has been effective, it has been found to be somewhat time consuming and inefficient. Thus, it would be desirable to provide an improved method and apparatus for balancing a driveshaft assembly that assists an operator in visually determining the location of this top dead center orientation and manually positioning the balance weight at that location.

### SUMMARY OF THE INVENTION

This invention relates to an improved method and apparatus for balancing an article for rotation about an axis by providing a visual indication on the outer surface thereof that precisely identifies the location at which a balance weight can be secured to the article to balance it for rotation. The balancing machine includes a motor for rotating the article at a predetermined speed. As the article is rotated, the balancing machine senses vibrations that are caused by imbalances in the structure of the article. The balancing machine is responsive to such vibrations for determining the size and location of one or more balance weights that, if secured to the article, will minimize or eliminate these imbalances. Once this is determined, the balancing machine ceases further rotation of the article to allow such balance weight to be secured to the outer surface thereof. To accomplish this, the balancing machine generates a first indication that advises the operator of the size of the balance weight that is necessary to counterbalance the sensed imbalance in the article. The balancing machine also generates a second indication that advises the operator when the location on the article at which the balance weight is to be secured is oriented at the top dead center position of the article. At the same time, a light emitter emits a beam of light that causes a narrow line to be illuminated along the top dead center position of the article. As a result, a clear visual indication is provided to the operator of the proper location to secure the balance weight to the article. Lastly, the balance weight is secured to the article using any conventional means, such as by welding, adhesives, and the like.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side elevational view of a conventional vehicular drive train system including a driveshaft assembly having a balance weight secured thereto in accordance with the method and apparatus of this invention.

FIG. 2 is a perspective view of a balancing machine in accordance with this invention having the driveshaft assembly illustrated in FIG. 1 mounted thereon.

FIG. 3 is a sectional elevational view of portions of the balancing machine and driveshaft assembly taken along line 3-3 of FIG. 2.

### DETAILED DESCRIPTION OF THE PREFERRED EMBODIMENT

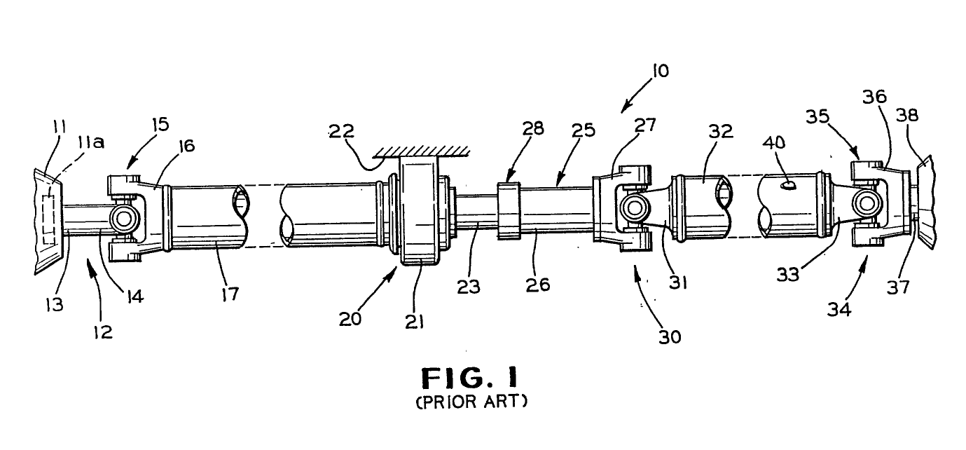

Referring now to the drawings, there is illustrated in FIG. 1 a drive train system, indicated generally at 10, for a vehicle that is adapted to transmit rotational power from an engine/transmission assembly 11 to a plurality of driven wheels (not shown). The illustrated drive train system 10 is conventional in the art and is intended merely to illustrate one environment in which this invention may be used. Thus, the scope of this invention is not intended to be limited for use with the specific structure for the vehicle drive train system 10 illustrated in FIG. 1 or to vehicle drive train systems in general. On the contrary, as will become apparent below, this invention may be used to balance any desired component or article for rotation.

The engine/transmission assembly 11 is conventional in the art and includes an externally splined output shaft (not shown) that is connected to a first slip yoke, indicated generally at 12. The first slip yoke 12 is conventional in the art and includes an end portion 13 having a smooth cylindrical outer surface and an internally splined inner surface (not shown). The internally splined inner surface of the end portion 13 of the first slip yoke 12 engages the externally splined output shaft of the engine/transmission assembly 11 in a known manner. As a result, the first slip yoke 12 is rotatably driven by the output shaft of the engine/transmission assembly 11, but is free to move axially relative thereto to a limited extent.

An annular seal 11a may be provided within or adjacent to the end of the engine/transmission assembly 11. The end portion 13 of the first slip yoke 12 extends through the annular seal 11a. In a known manner, the seal 11a engages and seals against the smooth outer cylindrical surface of the end portion 13 of the first slip yoke 12 to prevent dirt, water, and other contaminants from entering into the engine/transmission assembly 11. The seal 11a is conventional in the art and can be formed having any desired structure. To insure a reliable seal, however, it is usually important for the outer cylindrical surface of the end portion 13 of the first slip yoke 12 to be generally smooth and free from relatively large surface irregularities, such as nicks and dents. If desired, the seal 11a may be retained in an annular ridge (not shown) formed in the engine/transmission assembly 11.

The first slip yoke 12 further includes a yoke portion 14 that forms one part of a first universal joint assembly, indicated generally at 15. The first universal joint assembly 15 is also conventional in the art and includes a tube yoke 16 that is connected to the yoke portion 14 of the first slip yoke 12 by a cross in a known manner. The tube yoke 16 is secured, such as by welding, to a first end of a first driveshaft section 17 for rotation therewith. The first universal joint assembly 15 thus provides a rotational driving connection between the output shaft of the engine/transmission assembly 11 and the first driveshaft section 17, while permitting a limited amount of axial misalignment therebetween.

The first driveshaft section 17 extends through and is supported for rotation by a center bearing assembly, indicated generally at 20. The center bearing assembly 20 is conventional in the art and includes a rigid frame or bracket 21 that is secured to a support surface 22, such as a portion of a frame, chassis, or body of the vehicle. The first driveshaft section 17 has a second end 23 that, in the illustrated embodiment, is reduced in diameter relative to the first end of the first driveshaft section 17, although such is not necessary. The reduced diameter end 23 can be formed as a separate structure that is welded onto the larger diameter first end of the first drive shaft section 17. In any event, a portion of the outer surface of the reduced diameter second end 23 of the first driveshaft section 17 is formed having a plurality of external splines (not shown).

A second slip yoke, indicated generally at 25, is connected, such as by welding, to the reduced diameter second end 23 of the first driveshaft section 17 for rotation therewith. The second slip yoke 25 is conventional in the art and includes an end portion 26 having an internally splined inner surface (not shown). The internally splined inner surface of the end portion 26 of the second slip yoke 25 engages the externally splined portion of the second end 23 of the first driveshaft section 17 in a known manner. As a result, the second slip yoke 25 is rotatably driven by the first driveshaft section 17, but is free to move axially relative thereto to a limited extent.

An annular seal, indicated generally at 28, may be mounted on the end portion 26 of the second slip yoke 25. The reduced diameter second end 23 of the first driveshaft section 17 extends through the annular seal 28. In a known manner, the annular seal 28 engages and seals against the smooth outer cylindrical surface of the reduced diameter second end 23 of the first driveshaft section 17 to prevent dirt, water, and other contaminants from entering into the region of the cooperating splines. The seal 28 is conventional in the art and can be formed having any desired structure.

The second slip yoke 25 further includes a yoke portion 27 that forms one part of a second universal joint assembly, indicated generally at 30. The second universal joint assembly 30 is also conventional in the art and includes a tube yoke 31 that is connected to the yoke portion 27 of the second slip yoke 25 by a cross in a known manner. The tube yoke 31 is secured, such as by welding, to a first end of a second driveshaft section 32 for rotation therewith. The second universal joint assembly 30 thus provides a rotational driving connection between the second end 23 of the first driveshaft section 17 and the first end of the second driveshaft section 32, while permitting a limited amount of axial misalignment therebetween.

The second end of the second driveshaft section 32 is secured, such as by welding to a tube yoke 33 that forms one part of a third universal joint assembly, indicated generally at 34. The third universal joint assembly 34 is also conventional in the art and includes a third slip yoke, indicated generally at 35. The third slip yoke 35 is conventional in the art and includes a yoke portion 36 that is connected to the tube yoke 33 by a cross in a known manner. The third slip yoke 35 further includes an end portion 37 having a smooth cylindrical outer surface and an internally splined inner surface (not shown). The internally splined inner surface of the end portion 37 of the third slip yoke 12 engages an externally splined input shaft of a conventional axle assembly 38 that is connected to the plurality of driven wheels of the vehicle in a known manner. As a result, the input shaft of the axle assembly 38 is rotatably driven by the second driveshaft section 32, but is free to move axially relative thereto to a limited extent.

An annular seal (not shown) may be provided within or adjacent to the end of the axle assembly 38. The annular seal may be similar in structure and operation to the annular seal 11a described above. The end portion 37 of the third slip yoke 35 extends through the annular seal. In a known manner, the annular seal engages and seals against the smooth outer cylindrical surface of the end portion 37 of the third slip yoke 35 to prevent dirt, water, and other contaminants from entering into the axle assembly 38. The seal is conventional in the art and can be formed having any desired structure. To insure a reliable seal, however, it is usually important for the outer cylindrical surface of the end portion 37 of the third slip yoke 35 to be generally smooth and free from relatively large surface irregularities, such as nicks and dents. If desired, the seal may be retained in an annular ridge (not shown) formed in the axle assembly 38.

A balance weight 40 is secured to the outer surface of the second driveshaft section 32 or other portion of the drive train system 10. The balance weight 40 is conventional in the art and is sized and positioned relative to the second driveshaft section 32 and the remainder of the drive train system 10 so as to balance the second driveshaft section 32 and the remainder of the drive train system 10 for rotation about an axis during use. The balance weight 40 may be formed from any desired material and may be secured to the second driveshaft section 32 in any desired manner, such as by welding, adhesives, and the like. If necessary, a plurality of such balance weights 40 may be secured to the outer surface of the second driveshaft section 32 or other portion of the drive train system 10.

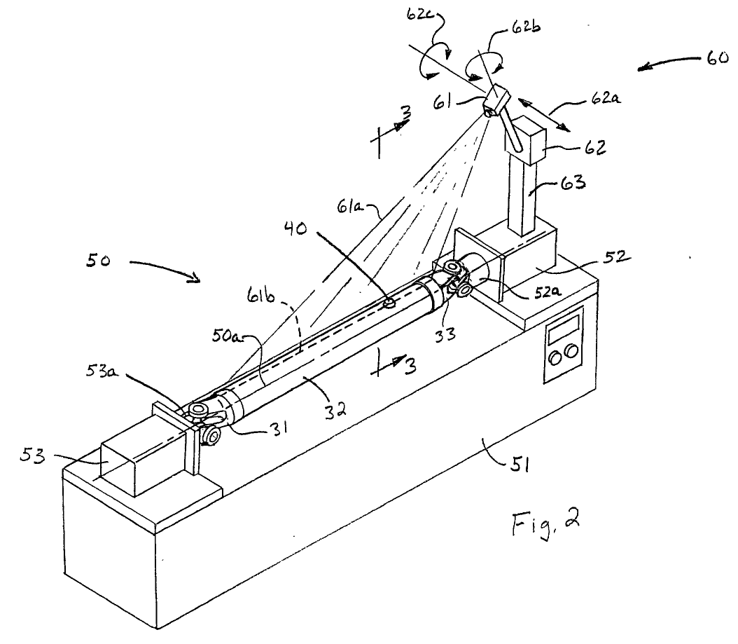

Referring now to FIG. 2, there is illustrated a balancing machine, indicated generally at 50, for determining the size and for positively identifying the location of one or more of the balance weights 40 to be secured on the second driveshaft section 32 (or elsewhere on the drive train system 10) to balance it and the remainder of the drive train system 10 for rotation in accordance with this invention. The balancing machine 50 is, in large measure, conventional in the art and includes a base 51 that supports a pair of spindle assemblies 52 and 53. The first spindle assembly 52 includes a fitting 52a that is adapted to engage and support the tube yoke 33 and the cross of the third universal joint assembly 34 provided at the second end of the second driveshaft section 32. Similarly, the second spindle assembly 53 includes a fitting 53a that is adapted to engage and support the tube yoke 31 and the cross of the second universal joint assembly 30 provided at the first end of the second driveshaft section 32. Typically, the fittings 52a and 53a are embodied as conventional yokes that cooperate with the universal joint assemblies 30 and 34 in the same manner as the yokes 36 and 27 respectively described above. The end fittings 52a and 53a are typically co-axially aligned with one another so as to define an axis of rotation 50a therebetween. Thus, when supported on the end fittings 52a and 53a, the second driveshaft section 32 is supported on the balancing machine 50 co-axially relative to this axis of rotation 50a.

The balancing machine 50 also includes a motor (not shown) for rotating the second driveshaft section 32 at a predetermined speed. The motor is typically provided within one of the spindle assemblies 52 and 53 and has an output shaft that is connected to at least one of fittings 52a and 53a. Thus, the fittings 52a and 53a are capable of being rotatably driven by the motor. The motor of the balancing machine 50 can be actuated to rotate the second driveshaft section 32 at any desired speed. Once the second driveshaft section 32 has reached this desired speed, measurements can be taken by one or more sensors (not shown) provided on or within the balancing machine 50 to determine the magnitude of any rotational imbalance of the second driveshaft section 32. In a manner that is well known in the art, the balancing machine 50 senses vibrations that are caused by these imbalances and is responsive to such vibrations for determining the size and location of one or more balance weights 40 that, if secured to the second driveshaft section 32, will minimize or eliminate these imbalances. Once this is determined, the balancing machine 50 ceases further rotation of the second driveshaft section 32 to allow the balance weight 40 to be secured to the outer surface thereof.

As mentioned above, the balancing machine 50 typically generates two indications to an operator thereof. The first indication represents the size of the balance weight 40 that is necessary to counterbalance the sensed imbalance in the second driveshaft section 32. This first indication is typically expressed as a numerical representation on a visual display (not shown) provided on the balancing machine 50, but can be provided in any desired manner. The second indication represents the location at which the balance weight 40 is to be secured to the second driveshaft section 32 to counterbalance the sensed imbalance. As discussed above, the balancing machine 50 typically allows an operator to manually rotate the second driveshaft section 32 until the location at which the balance weight 40 is to be secured thereto is positioned facing directly upwardly (i.e., a top dead center position). The balancing machine 50 typically provides a visual or audible indication to the operator when this top dead center orientation of the driveshaft assembly has been achieved.

However, rather than relying upon the operator of the balancing machine 50 to visually determine the location of this top dead center orientation and manually position the balance weight 40 at that location, this invention provides a mechanism for assisting the operator thereof in visually determining and accurately positioning the balance weight 40 at the top dead center or other predetermined reference position or orientation on the second driveshaft section 32 for subsequent securement to the outer surface thereof. To accomplish this, the balancing machine 50 includes light emitter assembly, indicated generally at 60. The light emitter assembly 60 is preferably mounted directly on the balancing machine 50 as shown. However, the light emitter assembly 60 can, if desired, be mounted on any other structure, provided that it is supported in a fixed position relative to the balancing machine 50 during use.

As best shown in FIG. 2, the light emitter assembly 60 includes a light emitter 61 that is adapted to emit a beam of light 61a that impinges upon and visually illuminates a desired portion of the second driveshaft section 32. Preferably, the light emitter 61 emits a narrow planar beam of light 61a on the second driveshaft section 32 such that a narrow line 61b is visually illuminated on the top dead center or other predetermined reference position or orientation on the second driveshaft section 32. However, if desired, the light emitter 61 can emit a narrow line of light on the second driveshaft section 32 such that only a small point or area is visually illuminated on the top dead center or other predetermined reference position or orientation on the second driveshaft section 32. As will be explained in greater detail below, the illuminated narrow line of light 61b provides a clear visual reference to assist the operator of the balancing machine 50 to precisely determine the proper mounting location for balance weight 40. The beam of light 61a can be any suitable visible wavelength, width, length, or intensity that provides the desired visual reference. For example, it has been found that a laser emitting a bright red beam having a wavelength of about six hundred fifty nanometers is sufficient to provide an easily discernable narrow line 61b on the surface of the second driveshaft section 32.

Preferably, the light emitter 61 is adjustably supported on or relative to the balancing machine 50 such that the direction of the beam of light 61a can be adjustably directed to shine on any desired location on the second driveshaft section 32. To accomplish this, the light emitter 61 can be supported on a positioning mechanism 62 that, in turn, is supported in an elevated manner relative to the balancing machine 50 by a support, such as a post 63. The positioning mechanism 62 is conventional in the art and is adapted to selective move or support the light emitter 61 in any desired position relative to the balancing machine 50, such as shown by the various axes of movement shown at 62a, 62b, and 62c in FIG. 2. If desired, the positioning mechanism 62 can be mechanically or electronically controlled so as to position the light emitter 61 in the desired orientation. Alternatively, the positioning mechanism 62 can be merely a flexible mechanical support structure that can be manually moved as desired to position the light emitter 61 in the desired orientation. Regardless of the manner in which the light emitter 61 is supported and positioned, however, the beam of light 61a can be directed to shine on any desired location on the second driveshaft section 32.

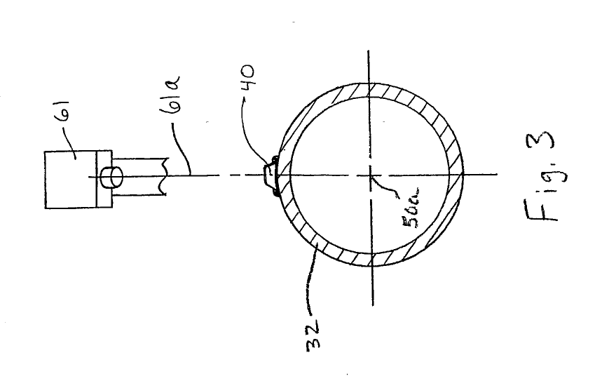

In operation, once the imbalance in the second driveshaft section 32 has been determined by the balancing machine 50 in the manner described above, further rotation of the second driveshaft section 32 is ceased to allow the balance weight 40 to be secured to the outer surface thereof. The balancing machine 50 generates the first indication that advises the operator of the size of the balance weight 40 that is necessary to counterbalance the sensed imbalance in the second driveshaft section 32. The balancing machine 50 also generates the second indication that advises the operator when the location on the second driveshaft section 32 at which the balance weight 40 is to be secured is oriented at the top dead center position of the second driveshaft section 32 (i.e., facing straight up) or some other predetermined reference position or orientation. At the same time, the light emitter 61 emits the beam of light 61a that causes the narrow line 61b to be illuminated along the top dead center position of the second driveshaft section 32 or other predetermined reference position or orientation. As a result, a clear visual indication is provided to the operator of the proper location to secure the balance weight 40 to the second driveshaft section 32, as shown in FIG. 3. Lastly, the balance weight 40 is secured to the second driveshaft section 32 using any conventional means, such as by welding, adhesives, and the like.

As mentioned above, the positioning mechanism 62 can be mechanically or electronically controlled so as to position the light emitter 61 in the desired orientation. For example, the operation of the positioning mechanism 62 can be coordinated with the operation of the balancing machine 50 such that the area of the outer surface of the second driveshaft section 32 that is illuminated varies with the rotational position of the second driveshaft section 32. In other words, the positioning mechanism 62 can control the direction of the beam of light 61a such that the narrow line 61b illuminates the precise position on the outer surface of the second driveshaft section 32 where the balance weight 40 should be located, regardless of the rotational orientation of the second driveshaft section 32. For example, if the second driveshaft section 32 was located near, but not precisely at, the top dead center position, then the positioning mechanism 61 would direct the beam of light 61a away from such top dead center position to the precise position on the outer surface of the second driveshaft section 32 where the balance weight 40 should be located.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method of balancing an unbalanced article for rotation comprising the steps of:
(a) determining the location on the article that, if a balance weight were to be secured thereto, would balance the article for rotation;
(b) emitting a beam of light on the location on the article to provide a visual indication on the article for positioning the balance weight at the location; and
(c) securing the balance weight to the article at the location.

2. The method defined in claim 1 wherein said step (a) is performed by mounting the article on a balancing machine and causing the article to be rotated to determine the location on the article.

3. The method defined in claim 1 wherein said step (b) is performed by providing a light emitter that generates the beam of light.

4. The method defined in claim 1 wherein said step (b) is performed by emitting a plane of light that causes a visual indication in the form of a line on the article for positioning the balance weight at the location.

5. The method defined in claim 1 wherein said step (b) is performed by emitting a line of light that causes a visual indication in the form of a point or region on the article for positioning the balance weight at the location.

6. The method defined in claim 1 wherein said step (b) is performed by emitting a beam of light in predetermined direction and orienting the article such that the location on the article is disposed within the beam of light.

7. The method defined in claim 1 wherein said step (b) is performed by emitting a beam of light in a direction that varies with the orientation of the article such that the location on the article is disposed within the beam of light.

8. A method of balancing an unbalanced driveshaft for rotation in a vehicle drive train system comprising the steps of:
(a) determining the location on the driveshaft that, if a balance weight were to be secured thereto, would balance the driveshaft for rotation;
(b) emitting a beam of light on the location on the driveshaft to provide a visual indication on the driveshaft for positioning the balance weight at the location; and
(c) securing the balance weight to the driveshaft at the location.

9. The method defined in claim 1 wherein said step (a) is performed by mounting the driveshaft on a balancing machine and causing the driveshaft to be rotated to determine the location on the driveshaft.

10. The method defined in claim 1 wherein said step (b) is performed by providing a light emitter that generates the beam of light.

11. The method defined in claim 1 wherein said step (b) is performed by emitting a plane of light that causes a visual indication in the form of a line on the driveshaft for positioning the balance weight at the location.

12. The method defined in claim 1 wherein said step (b) is performed by emitting a line of light that causes a visual indication in the form of a point or region on the driveshaft for positioning the balance weight at the location.

13. The method defined in claim 1 wherein said step (b) is performed by emitting a beam of light in predetermined direction and orienting the driveshaft such that the location on the driveshaft is disposed within the beam of light.

14. The method defined in claim 1 wherein said step (b) is performed by emitting a beam of light in a direction that varies with the orientation of the driveshaft such that the location on the driveshaft is disposed within the beam of light.
